(19) United States
(12) Patent Application Publication
(10) Pub. No.: US 2008/0223948 A1
(43) Pub. Date: Sep. 18, 2008

(54) Protection device for sprinkler

(76) Inventor: Wen-Li Guo, Chang Hua Hsien (TW)

Correspondence Address: CHARLES E. BAXLEY, ESQUIRE, 90 JOHN STREET, SUITE 309, NEW YORK, NY, 10038, US

(21) Appl. No.: 11/717,489

(22) Filed: Mar. 13, 2007

(51) Int. Cl. F15D 1/00

(52) U.S. Cl. 239/19

(57) ABSTRACT

A protection device for a sprinkler is connected between two rods of the sprinkler and includes two recessed support areas which are located beneath two extreme positions of a travel trace of the pivotable tube of the sprinkler. When the pivotable tube is pressed by a load, the pivotable tube is supported by either of the two recessed support areas so as to protect the gear mechanism from being damaged.

### FIELD OF THE INVENTION

The present invention relates to a protection device for supporting the pivotable tube of the sprinkler when the pivotable tube is overly rotated.

### BACKGROUND OF THE INVENTION

A conventional sprinkler is shown in FIG. 1 and generally includes a base with an inlet for being connected with a hose (not shown) and a gear mechanism is received in the base. Two parallel rods connected between the base and a frame which is located at a distance from the base. A pivotable tube is pivotably connected between the base and the frame. The water pressure activates the gear mechanism to pivot the pivotable tube back and forth, and the pivotable tube includes a plurality of apertures through which water goes out. However, the gears of the gear mechanism are made by plastic material and are broken or damaged if the pivotable tube is overly rotated by a foreign force such as a person steps on the pivotable tube. Once any one of the gears of the gear mechanism is damaged, the whole sprinkler is functionless.

The present invention intends to provide a protection device for protecting the pivotable tube of the sprinkler and the protection device includes two support areas which support the pivotable tube at the two extreme positions of the travel trace of the pivotable tube.

### SUMMARY OF THE INVENTION

The present invention relates to a sprinkler which comprises a base having an inlet defined in a first end thereof and two rods are connected between a second end of the base and a frame. The pivotable tube is driven by a gear mechanism in the base and includes a plurality of apertures. A protection device is connected between the two rods and includes two recessed support areas which are located beneath two extreme positions of a travel trace of the pivotable tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional sprinkler;

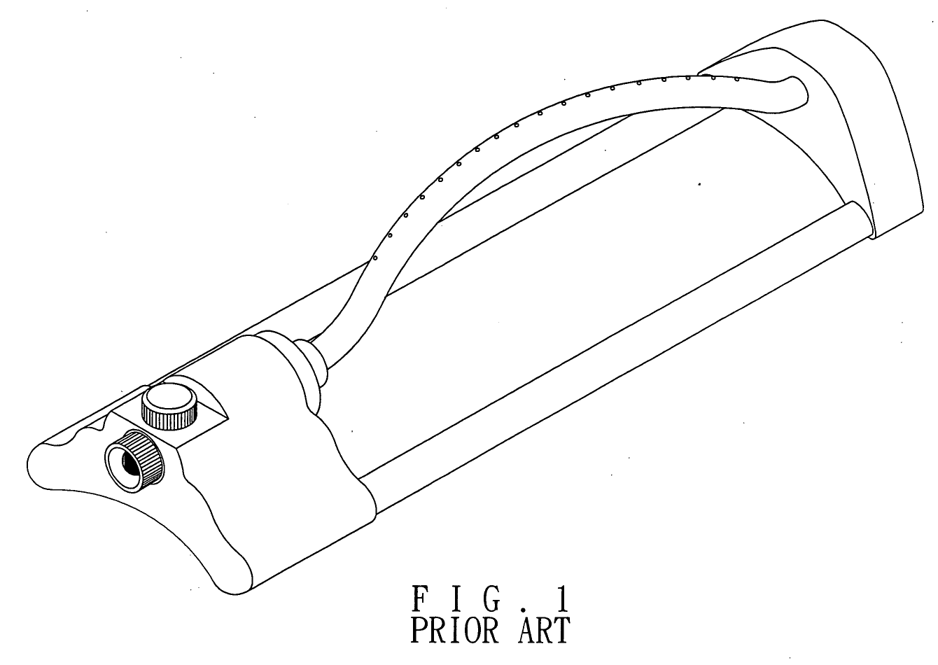

FIG. 2 shows the protection device and the sprinkler of the present invention;

FIG. 3 is an exploded view to show the protection device and the sprinkler of the present invention;

FIG. 4 is an end cross sectional view to show that the pivotable tube moves to one of the two extreme positions and is located above one of the two recessed support areas, and

FIG. 5 shows that the pivotable tube is stepped by a person and supported by the recessed support area of the protection device.

### DETAILED DESCRIPTION OF THE PREFERRED EMBODIMENT

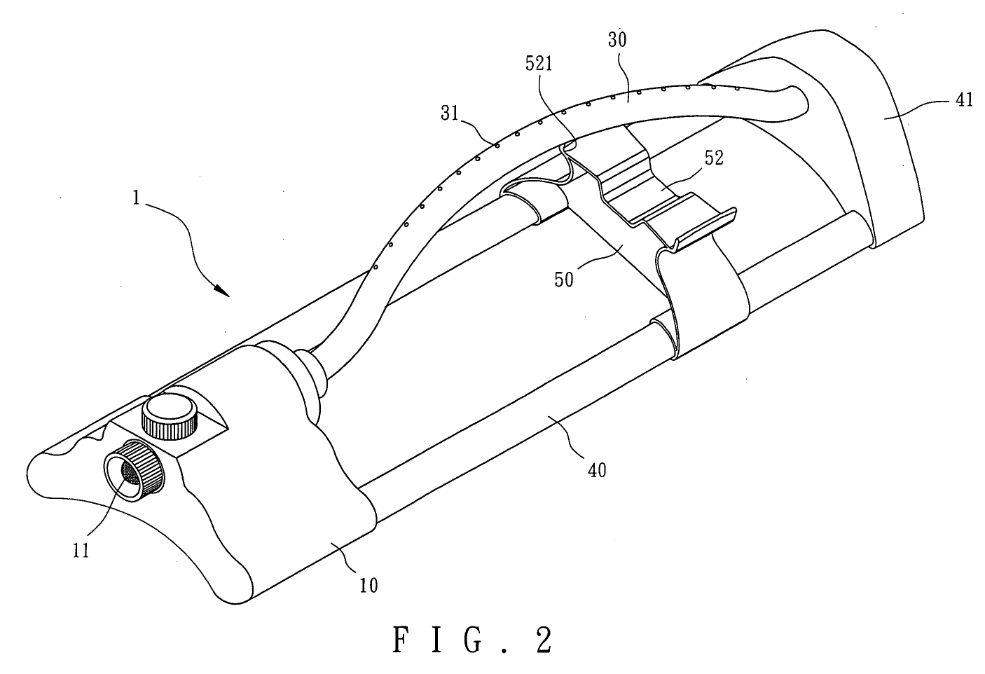

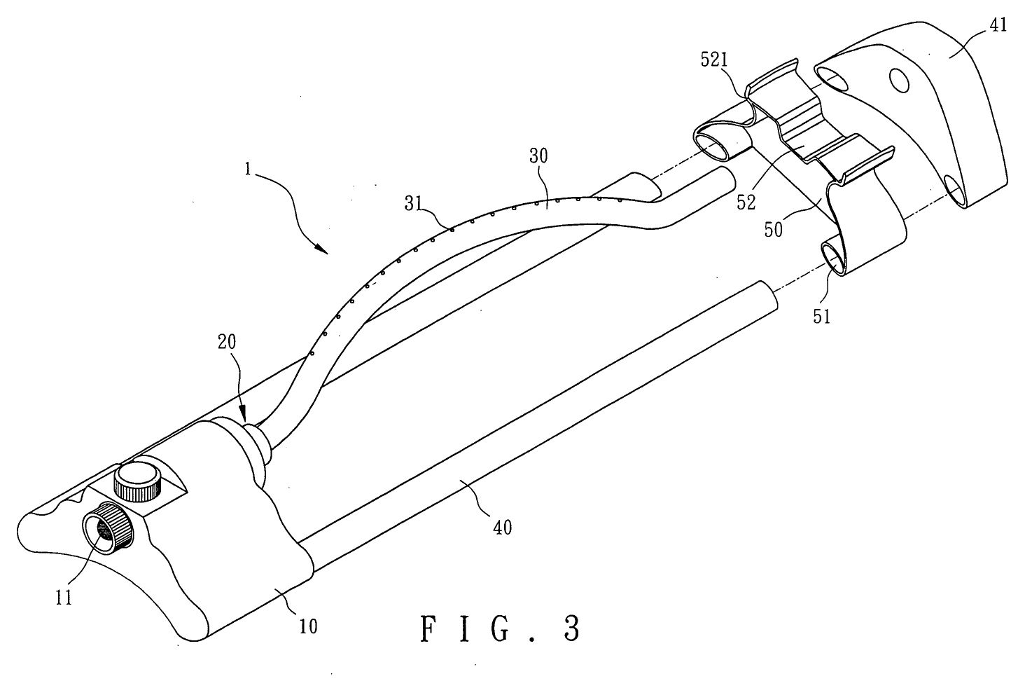

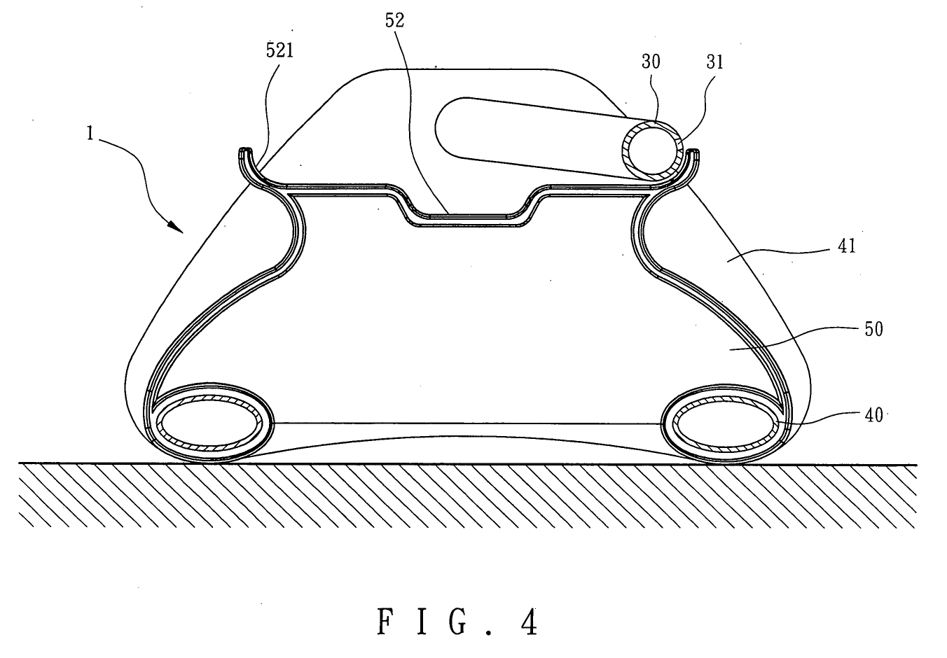

Referring to FIGS. 2 to 4, the sprinkler 1 of the present invention comprises a base 10 which having an inlet 11 defined in a first end thereof so as to be connected with a hose (not shown) through which water is introduced into the base 10. A gear mechanism 20 (not shown) is received in the base 10 and is driven by the water. Two rods 40 are connected between a second end of the base 10 and a frame 41.

A pivotable tube 30 pivotably connected between the base 10 and the frame 41. A plurality of apertures 31 are defined through a wall of the pivotable tube 30. The pivotable tube 30 is pivoted within a pre-set angular area and water springs out from the apertures 31 when the pivotable tube 30 is driven by the gear mechanism 20.

A protection device 50 is connected between the two rods 40 and includes two passages 51 through which the two rods 40 extend. A horizontal part is connected to a top of the protection device 50 and includes two recessed support areas 521 which are located beneath two extreme positions of a travel trace of the pivotable tube 30. A recessed portion 52 is located between the two recessed support areas 521. Each of the recessed support areas 521 is shaped to receive the pivotable tube 30.

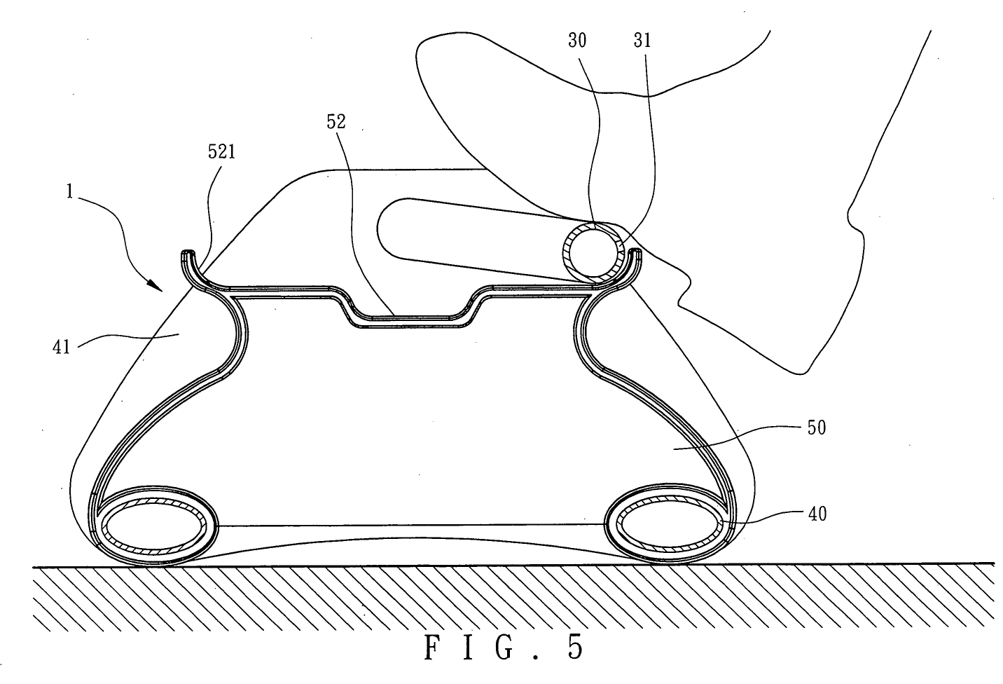

As shown in FIG. 5, when a person steps on the pivotable tube 30, the pivotable tube 30 is pivoted to one of the two extreme positions of its travel trace and is supported, by the recessed support area 521 corresponding thereto. By the support of the recessed support area 521, the pivotable tube 30 is stopped from overly pivoted such that the gear mechanism 20 can be protected.

While we have shown and described the embodiment in accordance with the present invention, it should be clear to those skilled in the art that further embodiments may be made without departing from the scope of the present invention.

What is claimed is:

1. A sprinkler comprising:
a base having an inlet defined in a first end thereof;
two rods connected between a second end of the base and a frame;
a pivotable tube pivotably connected between the base and the frame, a plurality of apertures defined through a wall of the pivotable tube, and
a protection device connected between the two rods and including two recessed support areas which are located beneath two extreme positions of a travel trace of the pivotable tube.

2. The device as claimed in claim 1, wherein the protection device includes two passages through which the two rods extend.

3. The device as claimed in claim 1, wherein each of the recessed support areas is shaped to receive the pivotable tube.

4. The device as claimed in claim 1, wherein a recessed portion is located between the two recessed support areas.
